(19) United States
(12) Patent Application Publication
(10) Pub. No.: US 2017/0113801 A1
(43) Pub. Date: Apr. 27, 2017

(54) CABIN MONITORING SYSTEM AND CABIN OF AIRCRAFT OR SPACECRAFT

(71) Applicant: Zodiac Aerotechnics, Plaisir (FR)

(72) Inventors: Yannick Brunaux, Croix (FR); Alison Gill, Toulouse (FR); Britta Appolt, Kuerten (DE); Sébastien Sivignon, Brax (FR); Claude Martin, Lury-sur-Arnon (FR)

(73) Assignee: Zodiac Aerotechnics, Plaisir (FR)

(21) Appl. No.: 15/126,673

(22) PCT Filed: Apr. 3, 2015
(86) PCT No.: PCT/EP2015/097019

§ 371 Date: Sep. 16, 2016

Related U.S. Application Data
(60) Provisional application No. 61/976,087, filed on Apr. 7, 2014.

(51) Int. Cl. B64D 11/00; B64D 47/08

(52) U.S. Cl. CPC B64D 11/00; B64D 47/08; B64D 11/062

(57) ABSTRACT

A monitoring system to be installed in a cabin (100a-100c) of an aircraft (100) or spacecraft for passenger transportation comprises at least one imaging device and at least one output device. Information displayed by the output device comprises indication of whether a passenger seat (110) in the cabin is occupied or empty. For more reliable information, several types of imaging devices may be used within the system, in particular selected among a visible light camera, a near-infrared lighting source combined with a near-infrared camera, a thermal camera, and a range imaging device.

The invention relates to a cabin monitoring system, and also to an aircraft or spacecraft cabin which comprises such cabin monitoring system.

### BACKGROUND OF THE INVENTION

During passenger transportation by air, passengers are asked to sit at their respective places in the aircraft during critical flight phases such as taxiing, takeoff and landing, and emergency periods such as the aircraft going through atmospheric turbulence areas. During these phases and periods, the crew members have to monitor the passengers in each cabin of the aircraft, for checking that each passenger correctly applies the instruction of staying in normal sitting position in his seat, possibly with the backrest of the seat in vertical position and the seat belt fastened.

In particular, this check task has to be carried out when each crew member is himself sitting on his dedicated seat, usually called crew attendant seat. To this end, regulations for passenger air transportation set that the crew attendant seats are located in the aircraft and oriented so that the crew member can view a prescribed minimum proportion of the passenger seats without leaving his own crew attendant seat. For example some of these regulations request that 50% of the passenger seats within each cabin of the aircraft can be viewed from the crew attendant seat, with a total above 80% for all passenger seats in the aircraft. Location and orientation of each crew attendant seat being suitable for meeting this requirement is then a constraint for the whole arrangement of the cabin. In particular, it may cause a reduction in the total number of passenger seats contained in the cabin, due to non-optimized floor print of the crew attendant seat. Such reduction in the number of passenger seats then causes benefit losses which may be very important over the commercial lifetime of the aircraft. It may also cause a reduction in the seat pitch, and/or in the area of the lavatories, and/or in the possible number of trolleys, and/or the area of the galleys. Other issues concerned with the location and orientation of the crew attendant seats are overall comfort of the passengers and space available for each passenger, safety during passenger circulation in the aisles and the relaxation areas of the aircraft, and also safety for circulation of service trolleys and crew members, ease for service operation with moving the trolleys, complex folding mechanisms for the crew attendant seats, reinforced supports for installing the crew attendant seats, etc.

Solutions already proposed for providing direct view to each crew member over an increased number of passenger seats include arranging mirrors at appropriate locations and using transparent bulkheads between adjacent cabins. But mirrors may be unaesthetic, cause injury to people inadvertently knocking into one of the mirrors, and is weight-increasing for the whole cabin content. Also transparent bulkheads are not desired because of preserved intimacy within each separate cabin.

Starting from this situation, one object of the present invention consists in allowing an increased view for each crew member over the passenger seats without being necessary for the crew member to leave his own crew attendant seat.

Another object of the invention consists in improving the overall comfort and safety conditions for the passengers and also for the crew members when circulating in the aisles or the relaxation areas of the aircraft.

Still another object of the invention consists in alleviating the constraints on the aircraft cabin arrangement due to the regulations related to the direct view over the passenger seats from each crew attendant seat.

### SUMMARY OF THE INVENTION

For meeting at least one of these objects or others, a first aspect of the present invention proposes a cabin monitoring system which is adapted for being installed in a cabin of an aircraft or spacecraft for passenger transportation, and which comprises:
at least one first imaging device; and
at least one output device, which is connected for outputting information derived from at least one image captured by the at least one first imaging device.

For example, the first imaging device may be selected among a visible light camera, a near-infrared lighting source combined with a near-infrared camera, a thermal camera, and a range imaging device. In the context of the invention, image generally denotes any data set which assigns a value to each pixel of a two-dimensional matrix. The assigned values may be light-intensity values as in usual images, but they may be also depth values which quantity the distances between imaged objects and the imaging device. In this latter case, the imaging device outputs 3D-images.

Each output device is intended to be dedicated to a crew member in charge of checking the passengers at their seats. To this purpose, the output devices are to be installed near at least some of the crew attendant seats or made available to the crew members during the critical flight phases. One same output device may also be shared between two crew attendant seats if these latter are close to each other.

Each output device may be selected among a display screen, a tablet, a signalling panel, a digital display and an audio device. In addition, in the context of the invention, “connected” for each output device means any suitable connection of this output device at least to the first imaging device, for data transmission and also possibly for power supply. Such connection may be direct or indirect, meaning that it may include any additional component effective for data transmission and/or intermediate data processing and/or power supply.

The imaging device or devices are to be installed in the cabin so that their fields of view encompass a maximum number of passenger seats. Possibly, several imaging devices are to be combined within the cabin monitoring system for viewing a greater number of passenger seats.

According to the invention, the system is adapted so that the information which is derived from the at least one image comprises indication of whether a passenger seat in the cabin is occupied or empty. In this way, it is possible, easier and more rapid for the crew member to check the position of an increased number of passengers in their respective seats, without leaving his own crew attendant seat.

Because the information is provided by means of the output device instead of direct line-of-sight, constraints on the locations and orientations of the crew attendant seats are alleviated. In this way, priority may be assigned to passenger comfort and safety, and also to ease in moving in the aisles and relaxation areas for the passengers and for the service operation by the crew members. In addition, savings in the floor prints of the crew attendant seats as resulting from the invention may lead to adding one or several passenger seats in the cabin. Benefits for the airline company resulting from each commercial flight of the aircraft are increased as a consequence. Alternatively or additionally, the invention may allow increasing the seat pitch, and/or the area of the lavatories, and/or the possible number of trolleys, and/or the area of the galleys.

In preferred embodiments of the invention, the cabin monitoring system may comprise a second imaging device, also possibly selected among a visible light camera, a near-infrared lighting source combined with a near-infrared camera, a thermal camera, and a range imaging device. Then the at least one output device may be adapted for outputting information derived separately from images which are captured respectively by the first and second imaging devices. For example such information may be displayed on a screen of the output device, within display windows which are dedicated separately to the imaging devices in the screen area. In this way, each imaging device may provide the crew member with additional information or image details, so that the overall information is more reliable. For example, the plurality of imaging devices may comprise at least two imaging devices of different types or also at least two imaging devices of the same type but situated at different locations within the cabin and oriented so as to image-capture one same cabin content with different lines of sight.

Also preferably, the cabin monitoring system may further comprise a processing unit which is arranged for processing the images captured by each imaging device.

When the cabin monitoring system comprises at least the first and second imaging devices, the processing unit may be adapted for performing a cross-correlation between images which are captured respectively by these two imaging devices. Then the information which is outputted by the at least one output device may be derived from the cross-correlation. Reliability of the information which is provided to the crew member may also be improved in this way. Preferably, the at least two imaging devices may be of different types among those cited before.

Generally, the processing unit may be also arranged for producing the information derived from the images by performing at least one among:
a comparison between a content of at least one of the images captured and a reference content;
a human shape detection which is performed from a content of at least one of the images captured;
a movement detection which is performed by content comparison between at least two of the images captured successively;
a human face recognition which is performed from a content of at least one of the images captured; and
a detection of objects or humans who are located within identified zones in the cabin and captured in at least one of the images.

In preferred embodiments of the invention, one or several of the following improvements may be implemented, separately or in combination of several of them:
the at least one imaging device may be connected to the at least one output device using transmission means. Such transmission means may be based at least in part on electrical wires, optical fibers or wireless transmission means when they are intended for data transmission. They may be based also electrical wires, optical fibers or induction effect when they are intended for power transmission. Possibly, same transmission means may attend to transmission of both data and power;
the cabin monitoring system may further comprise a backup power supply device which is adapted for allowing an operation of this cabin monitoring system independently from any other power source. In particular, such backup power supply device may allow operation of the cabin monitoring system for a duration sufficient for outputting the information which comprises the indication of whether a passenger seat in the cabin is occupied or empty;
the cabin monitoring system may be further adapted so that the information outputted also comprises indication about at least one among:
   whether a seat belt of the passenger seat is fastened or not;
   a backrest position for the passenger seat;
   a medical or health indication for a passenger present at the passenger seat; and
   behaviour of a passenger present in the cabin.

A second aspect of the invention proposes an aircraft or spacecraft cabin for passenger transportation, which cabin comprises a plurality of passenger seats and a cabin monitoring system according to the first aspect of the invention. Each output device may be intended for a crew member, so that this crew member can monitor at least part of the cabin based on the information outputted by his output device.

According to a further feature of the second invention aspect, the at least one imaging device is located and oriented in the aircraft cabin so that an occupied or empty state is shown for at least 50% of the passenger seats of the aircraft cabin from the information which is outputted by the at least one output device.

Preferably, the at least one imaging device may be located and oriented in the aircraft cabin so that the occupied or empty state is shown for at least 80% of the passenger seats of the aircraft cabin from the information outputted by the at least one output device.

Even more preferably, the at least one imaging device may be located and oriented in the aircraft cabin so that the occupied or empty state is shown for 100% of the passenger seats of the aircraft cabin from the information outputted by the at least one output device. Complete monitoring of the passenger seats is thus possible without necessary for the crew member to leave his own crew attendant seat.

Advantageously, one or several of the imaging devices of the cabin monitoring system may be located within the cabin above a height level corresponding to headrest parts of the passenger seats, in particular at a height level corresponding to a ceiling of the cabin. In this way, the field of view of the imaging device allows identifying more easily whether one passenger seat is occupied or not, or whether the passenger is sitting in an appropriate manner, or what is the position of the backrest of the passenger seat, and such for a greater proportion of the passenger seats in the cabin.

When the aircraft or spacecraft cabin comprises at least one aisle, the cabin monitoring system may be further adapted so that the information derived comprises indication about humans or objects being in the aisle. This may be useful for improving coordination for service operations such as lunch service, and also for regulating the boarding of the passengers when circulation in the aisle is jammed with passengers already onboard.

Optionally, the cabin monitoring system may be further adapted to be connected to a check-in recorder which is arranged for access-control before getting into the aircraft or spacecraft. Then, it may be further adapted for cross-correlating a number of passengers who have passed through the access-control, and a number of passengers who have got into the aircraft or spacecraft. Alternatively or in combination, it may also be further adapted for cross-correlating data about passengers to go aboard the aircraft or spacecraft, received from the check-in recorder, and the passenger seats which become occupied with passengers upon a boarding phase of the aircraft or spacecraft.

Also optionally, when the cabin monitoring system comprises a backup power supply device, it may be adapted for operating independently from any power source other than the backup power supply device during periods corresponding to taxiing, takeoff, landing, and the aircraft or spacecraft going through a turbulence area.

These and other features of the invention will be now described with reference to the appended figures, which relate to preferred but not-limiting embodiments of the invention.

### BRIEF DESCRIPTION OF THE DRAWINGS

FIG. 1 is a block diagram showing components of a cabin monitoring system according to the invention; and

FIG. 2 is a layout of an aircraft for passenger air transportation, equipped with a cabin monitoring system of the invention.

### DETAILED DESCRIPTION OF THE INVENTION

Reference numbers used in the figures and now listed have the following meanings:
1a to 1d separate imaging devices, for example at least four imaging devices
2a to 2c separate output devices, for example at least three output devices processing unit
3a library for access by the processing unit
4a connections for transmitting image data from the imaging devices to the processing unit
4b connections for transmitting data from the processing unit to the output devices
5 battery for supplying energy to the processing unit, each imaging device and each output device
6 check-in recorder
100 aircraft as a whole
100a-100c three cabins for passengers within the aircraft
101 aircraft power system
102a-102b aisles for example for a two-aisle layout of the aircraft
103a-103d relaxation areas, for example with cafe service and toilets
110 passenger seats
111 crew attendant seats

Each imaging device 1a-1d may be a standard camera suitable to capture images with visible light. Such camera is available commercially a very low unit cost and can be installed easily at any location in one of the cabins 100a-100c of the aircraft 100.

Alternatively, each imaging device 1a-1d may be a combination of a near-infrared lighting source with a corresponding camera sensitive to radiation pertaining to the emission range of the near-infrared lighting source. In the context of the present description, near-infrared radiation means radiation with wavelength comprised between 0.760 μm (micrometer) and 2 μm. Imaging devices of this second type may provide images with stronger contrast depending of the difference between the lighting direction of the source and the image capture direction of the camera, because the radiation used by such imaging device does not belong to the ambient light as existing in the aircraft.

Each imaging device 1a-1d may also be a thermal camera, providing high contrast for bare parts of human bodies such as the passenger faces.

Each imaging device 1a-1d may also be a range imaging device. Several kinds of range imaging devices are available commercially. For example, such device may be comprised of a near-infrared light pattern projecting unit and at least one camera operating in the same radiation range as the projecting unit. The light pattern may comprise a series of spots located at the nodes of a square network. Then, objects or humans which are located at various distances from the projecting unit cause alterations in the spot distribution when viewed by the camera away from the optical axis of the projecting unit. Known image processing is used for deriving the distances of the objects or humans from the alterations in the spot distribution as captured by the camera. Several cameras with different locations and orientations, but directed toward the scene covered with the spot network, may be used in parallel for improving the accuracy of the distances as determined by the image processing. Other devices for range imaging but based on different principles are also available, and well known to the Man skilled in object or movement detection. In particular, image ranging devices also exist which are based on time-of-flight detection.

Preferably, at least two among the imaging devices 1a-1d are dedicated to capture images of a same part of one aircraft cabin, but these two imaging devices are of two different types among those listed just above. In this way, a same content of the aircraft cabin is analyzed using at least two different information capturing means, leading to increased reliability. One major application of the invention is detecting whether an identified passenger seat within the cabin is occupied or not. Such detection may be performed by searching for and recognizing a human face or a human body structure in an image captured by a visible light camera or near-infrared camera, or by looking for a bright signal area within an image captured by a thermal camera at a location in the image corresponding to the face of a passenger installed in the seat, or also by range analysis performed at the location of the seat. In particular, such redundancy may allow discriminating more easily between several positions of the passenger on the seat, or discriminating between an adult and a child occupying the seat, so that suitable monitoring or intervention can be attended to by the crew member.

Each of the imaging devices 1a-1d may be provided with a wide-angle lens at its optical entrance, for increasing the part of the cabin which is imaged at each image capture. Thus, the total number of imaging devices which is necessary for monitoring the cabin can be reduced.

It may also be advantageous that each of the imaging devices 1a-1d is provided locally in the aircraft with a dedicated power source for supplying this imaging device with energy. Such dedicated power source may be in particular a battery, a capacitor set, a fuel cell or a system based on Peltier effect. Because each of these power sources supplies power to a limited part of the cabin monitoring system, nominally one imaging device, it can be small and reduced in weight. Possibly, a same one of the local power sources may be connected to several imaging devices, for providing a backup energy supply to one of these imaging devices when the power source dedicated to this latter is in failure. In this way, redundancy can be provided for the power supply of the imaging devices.

The image analysis is performed by the processing unit 3. To this purpose, the imaging devices 1a-1d are connected to the processing unit 3 using the connections 4a.

The connections 4a may be adapted for transmitting the whole images as captured, so that maximum image content is available to the processing unit 3 for analysis and/or cross-correlation between images originating from several of the imaging devices 1a-1d. The connections 4a may be of any type known in the art: electrical wiring, optical fiber connections or wireless connections, for example suitable for WIFI transmission or any proprietary air or wireless transmission mode. The connections 4a may also be used for transporting power to the imaging devices 1a-1d.

Each output device 2a-2c may be any terminal unit, including screen-based device, tablet, signalling panel, digital display or audio device. For example, such output device may be adapted for showing a map of the aircraft cabin with the seat locations, and for indicating with appropriate signals that each seat is occupied or empty. In particular, the signalling may be produced with LEDs in on-state or off-state at locations in the signalling panel corresponding to the passenger seats. Such LED-based output device may be very low in power consumption. Alternatively, the output device may produce at least one representation of the aircraft cabin or parts of it as captured by the imaging devices 1a-1d, which shows the passenger seats contained in this cabin. Possibly, several of the output devices 2a-2c may be dedicated each to monitoring only the interior of one of the cabins 100a-100c, and a main output device may be dedicated to overview all the cabins 100a-100c of the aircraft 100. In some embodiments of the invention, each output device may comprise a digital display screen with display windows dedicated for viewing the images which are captured by different ones of the imaging devices 1a-1d. The display windows may be available simultaneously in separate areas of the screen, or alternatively by appropriate selection in a menu operated by a crew member who uses the output device for carrying out the monitoring of the aircraft cabin. Preferably, the output devices 2a-2c are installed at the crew attendant seats in the cabin or in proximity of them. In alternative embodiments of the invention, each output device 2a-2c may be a mobile terminal available to a crew member, such as a tablet for example. Each tablet may display the images produced by any one of the imaging devices 1a-1d upon appropriate menu selection, or display higher-level information as produced by the processing unit 3.

The output devices 2a-2c are connected to the processing unit 3 by the transmission connections 4b. These connections 4b may be of the same types as the connections 4a already described. The connections 4b may also be used for transporting power to the output devices 2a-2c.

The battery 5 has been called backup power supply device in the general part of the description. Preferably, the battery 5 is able to supply the entire cabin monitoring system autonomously with enough energy for providing the crew members with information about the occupied or empty state of each passenger seat. But it is preferable that the battery 5 also allows the cabin monitoring system to provide additional information, for example about humans or objects present in each aisle 102a-102b. Such operation of the cabin monitoring system is preferably independent from any extra power source other than the battery 5, so that monitoring information is available even during critical flight phases for which such extra power source may be disconnected. In particular, the cabin monitoring system can operate autonomously during the periods of aircraft taxiing, aircraft takeoff, aircraft landing, and the aircraft going through a turbulence area. But the battery 5 may be connected again to the extra power source for energy refilling periods. For example, such extra power source which may be used for energy-refilling of the battery 5 may be the aircraft power system 101, including an alternator of the aircraft 100. Possibly, the battery 5 may be replaced with one among a capacitor set, a fuel cell, a system based on Peltier effect, or any combination thereof for forming the backup power supply device.

The processing unit 3 is also connected to access the library 3a. This library 3a may be a lookup table, or any structure suitable for storing information or content elements. For example, the library 3a may contain a series of objects or human faces or human body positions to be searched in the images captured.

In simple embodiments of the invention, each output device 2a-2c displays information which is derived from the captures performed by the imaging devices 1a-1d, independently from each other. Such displayed information may be the images themselves as captured, without content of the images being analyzed, interpreted or completed by the processing unit 3.

But improved embodiments of the invention may involve special image content analysis which is performed by the processing unit 3, and the output devices 2a-2c may display results of such image content analysis. Put another way, the output devices 2a-2c may display higher-level information which is produced by the processing unit 3 from the images captured by the imaging devices 1a-1d.

When such higher-level information is derived from separate images, it may be obtained from a comparison between a content of one image captured and a reference content. Such comparison-based analysis may be useful for detecting whether a passenger seat 110 is occupied or empty, for example, or whether humans or objects such as service trolleys are situated in the aisles 102a-102b. It may also be useful for checking whether a seat belt is fastened or not, or whether a backrest of a passenger seat is in vertical position when requested.

Other image analyses which may be performed by the processing unit 3 from separate images may involve human shape detection or human face recognition. Softwares appropriate to such purposes are available. It is thus possible to check that a passenger is sitting at his place in a suitable position for ensuring safety. It is also possible to compare the faces of the passengers installed in the aircraft 100 with check-in records, for example for implementing a further security control of the passengers which are actually onboard.

Still other image analyses may involve content comparison between at least two images which have been captured successively by a same one of the imaging devices 1a-1d. Such time-analysis may be useful for detecting any movement or variation which would occur within the field of view of the imaging device. In particular, it is thus possible to collect medical or health indications about a passenger present at one of the passenger seats 110, or to collect observations about the behaviour of a passenger who is present in one of the cabins 100a-100c. Such behaviour observations may be useful in particular for identifying possible hijacker or nervous passenger, in order to trigger or implement appropriate actions.

Still other image analyses may involve cross-correlation between images which have been captured by two or more separate ones of the imaging devices 1a-1d oriented towards one same part of aircraft cabin. The imaging devices used in this purpose may be of one same type but with different lines of sight each towards the same cabin part. But preferably, the imaging devices used for such cross-correlation may be of different types among visible light camera, a near-infrared lighting source combined with a near-infrared camera, a thermal camera and a range imaging device, so that the imaging devices are complementary relative to one another for sensitivity and contrast. In this way, the information collected from the cross-correlation is more reliable than that resulting from the images captured by a single one of the imaging devices.

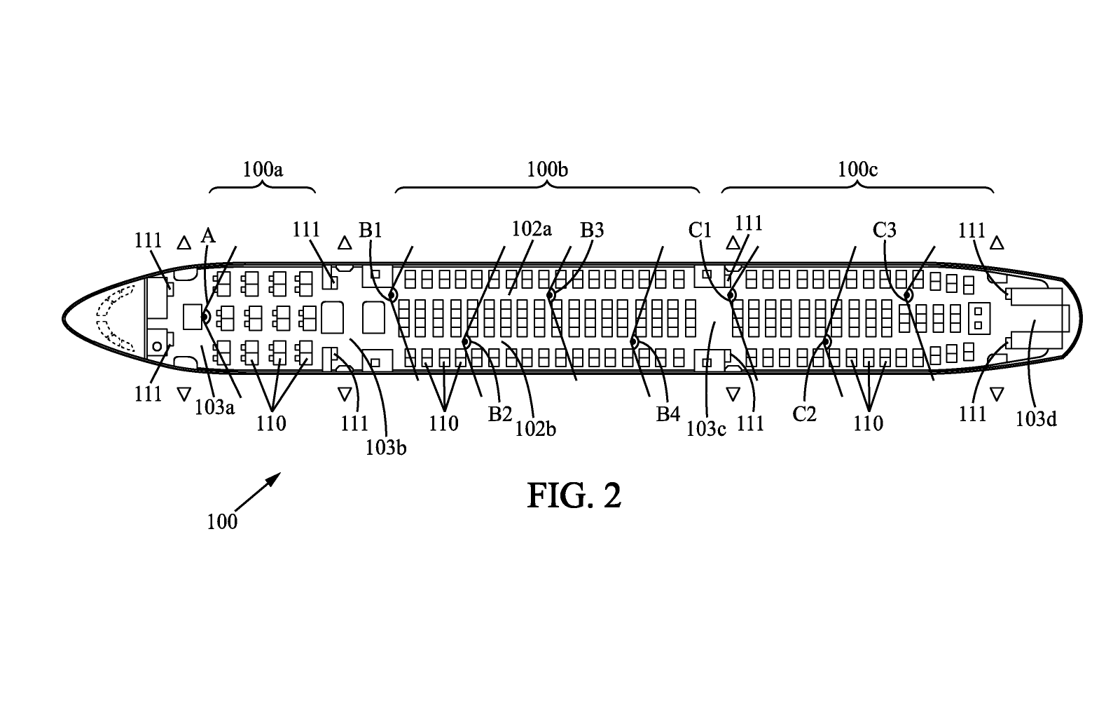

The aircraft layout of FIG. 2 is supplied only for illustrating a possible implementation of the cabin monitoring system just described. As an example, this layout comprises three cabins 100a-100c, two aisles 102a-102b and four relaxation areas 103a-103d. Usually at least two of these relaxation areas correspond to boarding access or emergency door of the aircraft 100. Usually also, the crew attendant seats 111 are located in or close to the relaxation areas 103a-103d.

Each crew attendant seat 111, or at least some of them may be equipped with an output device pertaining to the cabin monitoring system. Possibly, three separate cabin monitoring systems may be dedicated separately to the cabins 100a-100c, but preferably all cabins are concerned with one common system, with at least one cabin available for monitoring from each one of the output devices. In addition, a main output device dedicated to the chief crew member may allow monitoring the three cabins 100a-100c.

Then the issue is to locate the imaging devices in each cabin so that a desired proportion of the passenger seats 110 is within the field of view of at least one of the imaging devices. According to the invention, at least 50% of the passenger seats within each cabin 100a-100c are contained in the field of view of at least one of the imaging devices which are dedicated to this cabin.

For the passengers sitting in the seats 110 to appear clearly in the images as captured by the imaging devices, it may be advantageous to install the imaging devices at fixed locations above a height level which corresponds to the headrest parts of the passenger seats 110. More preferably, the imaging devices may be installed at the cabin ceiling level, for reducing probability for an object or human body part to mask the field of view of one of the imaging devices.

As for a first example, reference letter A denotes the location at ceiling level and the orientation of a first imaging device which is dedicated to the monitoring of the cabin 100a. It is represented in FIG. 2 as an angular sector, with orientation and angular aperture matching those of the field of view of the imaging device. One can see from the figure that the location and orientation A for the imaging device in cabin 100a allows imaging more than 50% of the passenger seats of this cabin within each image.

Locations and orientations B1-B4 in the cabin 100b also allow imaging more than 50% of the passenger seats 110 of this cabin, from an image set captured by four imaging devices which are respectively located at B1-B4.

In a similar manner, locations and orientations C1-C3 in the cabin 100c allow imaging more than 50% of the passenger seats 110 of this latter cabin, from another image set captured by three imaging devices respectively located at C1-C3.

In this manner, the cabin monitoring system comprising the imaging devices which are installed at the locations and orientations A, B1-B4 and C1-C3 can be said to provide “direct view” over more than 50% of the passenger seats 110 in each cabin.

Obviously, the locations and orientations A, B1-B4 and C1-C3 for the imaging devices are provided as non-limiting examples, and other location and orientation sets within each cabin 100a-100c can be implemented alternatively, possibly with location numbers per cabin which are different from those of the previous example. Such alternative location and orientation sets may be designed so that the occupied or empty state can be identified for at least 80% of the passenger seats 110 in each cabin 100a-100c, or possibly 100% of the passenger seats 110. For example, several imaging devices may be located above each block of passenger seats, along a middle line of the block which is parallel to the longitudinal axis of the aircraft 100.

The locations and orientations A, B1-B4 and C1-C3 for the imaging devices as implemented in the aircraft layout of FIG. 2 also allow detecting passengers or crew members or objects which are situated in the aisles 102a and 102b. Appropriate image analysis performed by the processing unit 3 may allow distinguishing between a human and an object such as a service trolley or a luggage. Possibly, the analysis may also distinguish between a crew member and a passenger, for example based on features of the crew member uniform.

In preferred implementations of the invention, at least two imaging devices of different types among visible light camera, near-infrared lighting source combined with near-infrared camera, thermal camera and range imaging device, may be installed at each location A, B1-B4 and C1-C3 with same orientation and same field of view for the imaging devices at a same one of these locations. In this way, the cross-correlation between the images which are captured by the imaging devices at a common location is easier to work out, and high-level information can be obtained more efficiently and with less hardware resources within the processing unit 3.

For improving the cabin monitoring, the system of the invention may also be used as a closed circuit television system.

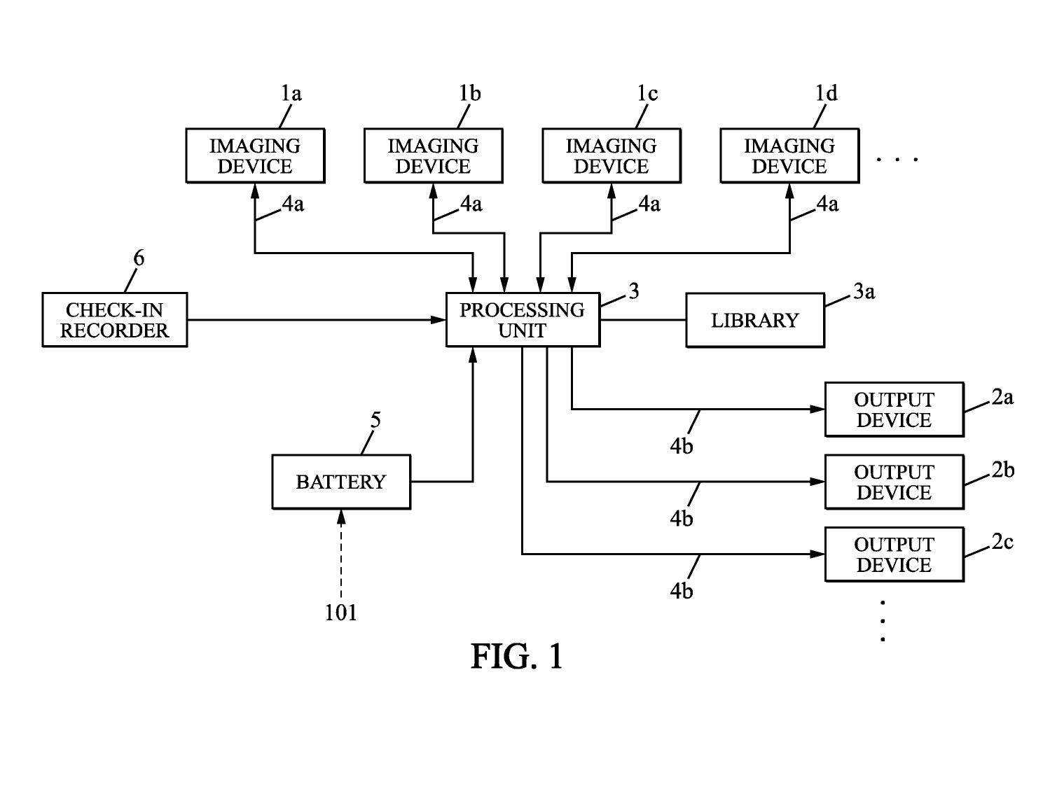

Another additional application of a cabin monitoring system according to the invention may result from connecting this system so that the processing unit 3 receives records of the passengers obtained upon check-in prior to boarding. Connection between the check-in recorder 6 and the processing unit 3 as represented in FIG. 1 may be dedicated to this purpose. The check-in recorder 6 may be installed at an access-control point to be passed through by the passengers prior to boarding. Such record or records obtained prior to boarding may be limited to a passenger count, or may comprise face capture of the passengers or scanning of their identity photographs from their passports. Then, the cabin monitoring system installed within the aircraft 100 may allow checking that each passenger has actually reached his seat in the aircraft, provided that the system is equipped with human face detection to be applied on the images captured by the imaging devices, and human face recognition to be applied between the records from the check-in and the images captured onboard.

Obviously, the invention can be implemented in an aircraft whatever the cabin number inside the aircraft, and whatever the passenger number in each cabin and the total passenger number in the aircraft.

Although the invention has been described in detail for an aircraft, it can also apply to a spacecraft for passenger transportation, and the Man skilled in the art will be able to adapt the secondary implementation aspects to such transportation vehicle.

1. Cabin monitoring system adapted for being installed in a cabin of an aircraft or spacecraft for passenger transportation, said system comprising:
at least one first imaging device; and
at least a output device connected for outputting information derived from at least one image captured by the at least one first imaging device,
wherein said system is adapted so that the information derived from the at least one image comprises indication of whether a passenger seat in the cabin is occupied or empty.

2. Cabin monitoring system according to claim 1, further comprising a second imaging device, wherein the at least a output device is adapted for outputting information derived separately from images captured respectively by said first and second imaging devices.

3. Cabin monitoring system according to claim 1, further comprising a processing unit arranged for processing images captured by each imaging device.

4. Cabin monitoring system according to claim 2, wherein the processing unit is adapted for performing a cross-correlation between images captured respectively by said at least first and second imaging devices, and the at least one output device is adapted for outputting information derived from the cross-correlation.

5. Cabin monitoring system according to claim 3, wherein the processing unit is further arranged for producing the information derived from the images captured by performing at least one among:
a comparison between a content of at least one of the images captured and a reference content;
a human shape detection performed from a content of at least one of the images captured;
a movement detection performed by content comparison between at least two the images captured successively;
a human face recognition performed from a content of at least one of the images captured; and
a detection of objects or humans located within identified zones in the cabin and captured in at least one of the images.

6. Cabin monitoring system according to any one of the preceding claim 1, wherein each imaging device is connected to the at least one output device using transmission means.

7. Cabin monitoring system according to claim 1, wherein the cabin monitoring system further comprises a backup power supply device adapted for allowing an operation of said cabin monitoring system independently from any other power source.

8. Cabin monitoring system according to claim 1, further adapted so that the information outputted also comprises indication about at least one among:
whether a seat belt of the passenger seat is fastened or not;
a backrest position for the passenger seat;
a medical or health indication for a passenger present at the passenger seat; and
behaviour of a passenger present in the cabin.

9. Aircraft or spacecraft cabin for passenger transportation, comprising:
a plurality of passenger seats; and
a cabin monitoring system according to claim 1.

10. Aircraft or spacecraft cabin according to claim 9, wherein the at least one first imaging device is located and oriented in the cabin so that an occupied or empty state is shown for at least 50%, preferably at least 80%, most preferably 100%, of the passenger seats of the cabin from the information derived from said at least one image.

11. Aircraft or spacecraft cabin according to claim 9, wherein the at least one first imaging device is located within the cabin above a height level corresponding to headrest parts of the passenger seats, in particular at a height level corresponding to a ceiling of the cabin.

12. Aircraft or spacecraft cabin according to claim 9, wherein the aircraft or spacecraft cabin further comprises at least one aisle, and wherein the information derived also comprises indication about humans or objects being in the aisle.

13. Aircraft or spacecraft cabin according to claim 9, wherein the cabin monitoring system is further adapted to be connected to a check-in recorder which is arranged for access-control before getting into the aircraft or spacecraft.

14. Aircraft or spacecraft cabin according to claim 13, wherein said cabin monitoring system is also adapted for cross-correlating a number of passengers who have passed through the access-control, and a number of passengers who have got into the aircraft or spacecraft.

15. Cabin according to claim 13, wherein said cabin monitoring system is also adapted for cross-correlating data about passengers to go aboard the aircraft or spacecraft, received from the check-in recorder, and passenger seats which become occupied with passengers upon a boarding phase of the aircraft or spacecraft.
